(19) United States
(12) Patent Application Publication
(10) Pub. No.: US 2007/0266579 A1
(43) Pub. Date: Nov. 22, 2007

(54) MULTIPLE-USE GONIOMETER

(76) Inventors: Larry G. Briscoe, Kansas City, MO (US); Brian S. Mills, Prairie Village, KS (US)

Correspondence Address: HOVEY WILLIAMS LLP, 2405 GRAND BLVD., SUITE 400, KANSAS CITY, MO, 64108, US

(21) Appl. No.: 11/419,591

(22) Filed: May 22, 2006

(51) Int. Cl. G01B 5/004

(52) U.S. Cl. 33/503

(57) ABSTRACT

An improved, multiple-use range of motion goniometer (20) is provided having a handle (22) and an angle-indicating assembly (24) having a pair of angle-indicating arms (26, 28) supported by the handle (22). Preferably, the goniometer arms (26, 28) have corresponding circular bases (30, 32) which are coupled together via a pivot assembly (34). A secondary, gravity-operated, track and ball range of motion measurement device (70) is also secured to the bases (30, 32). An auxiliary base (25) secured to the handle (22) and is moveable between a recessed storage position and an extended use position. The outer base (30) is provided with thumb movement surfaces in the form of apertures (56), allowing the therapist holding the handle (22) to rotate the outer base (30) relative to the inner base (32) with one hand.

### BACKGROUND OF THE INVENTION

1. Field of the Invention

The present invention is broadly concerned with improved, multiple-use goniometers having a handle as well as a dual-arm angle indicating assembly which can be placed adjacent a patient's joint in order to provide range of motion measurements. The handle supports a pair of elongated angle-indicating arms which can be manipulated by a therapist using only one hand. The preferred goniometer also includes a secondary, gravity-operated, track and ball angle measuring device, as well as an auxiliary base.

2. Description of the Prior Art

Goniometers are instruments which measure the range or extent of movement of flexing joints such as the knee, ankle, wrist, shoulders, hips, and fingers. These devices are commonly used during the course of therapy after injuries or illnesses which affect joint movement, in order to provide an indicator of the extent of the patient's recovery. Generally available present-day goniometers are simple instruments having two arms hinged together with an angular scale. In use, the arms are positioned in alignment with the body parts adjacent to the joint, and the patient then flexes the joint. A second, followup measurement is taken at a subsequent session. The second measurement is then compared to the initial measurement, indicating a gain or loss of joint range of motion. Typical goniometers of this character are illustrated in U.S. Pat. Nos. 1,590,499 and 3,270,420. More complex goniometers have been provided in recent years including automated readout functions and complex arrangement for securing the devices to various body parts, see, e.g., U.S. Pat. Nos. 4,306,571, 4,436,099, 5,263,492, and 5,792,077. Additionally, specialized goniometers designed only for particular body parts such as ankles have also been provided, such as that depicted in U.S. Pat. No. 4,771,548.

Gravity-operated liquid bubble devices have also been used to measure range of motion of wrist rotation and the like, where indicating arm measurements are not feasible. However, over time these devices tend to lose their liquid owing to leakage, and become inoperative.

Despite the plethora of prior goniometers, a number of significant problems remain. One such difficulty is that a therapist must have and maintain a variety of different goniometers useful for range of motion measurements of various different body parts. This creates storage and handling problems, particularly if the therapist travels to the homes of patients. Additionally, the simple dual-arm goniometers require two-handed use. That is to say, the therapist must grasp the two arms in his or her hands, and move the arms into the correct alignment with the appropriate body parts. This means that the therapist does not have a free hand to assist the patient, which is sometimes necessary with elderly or burn patients. As such, range of motion measurements may require the services of two therapists. Moreover, such two-handed operation means that the therapist does not have a free hand to record range of motion results. Again, this materially increases the complexity and cost associated with range of motion measurements.

There is accordingly, a real and unsatisfied need in the art for improved goniometers having essentially universal applicability and capable of one-handed use by a therapist.

### SUMMARY OF THE INVENTION

The present invention overcomes the problems outlined above and provides a multiple-use goniometer comprising a handle and an angle-indicating assembly operatively coupled with and supported by the handle, the assembly including a pair of elongated, angle-indicating arms pivotal relative to each other and selectively moveable to establish different angles between the arms. Pivot structure operatively couples the handle and the arms, preferably through a common pivot axis.

The preferred goniometers of the inventions include enlarged inner and outer bases each supporting an elongated arm component. The bases are pivotally coupled together by the pivot structure, and a generally circular and in alignment with each other. In order to provide one-handed operation, a series of thumb movement surfaces are provided on the outer base. In this fashion, a therapist holding the goniometer by the handle can use his or her thumb to rotate the outer base and the associated arm. In preferred forms, the thumb movement surfaces comprise a series of openings provided in the outer base, but in alternate forms these surfaces can be recesses or frictional contact areas. The outer base and arms are preferably provided with angular and distance scales, respectively.

The goniometers of the invention also preferably have a separate, gravity-operated angular measurement device which can be used independently of the angle-indicating arms. Such a device may be mounted on the outer base of the goniometer and include a circular track having a ball seated therein. Upon rotation of the goniometer, the ball moves underneath the influence of gravity to provide a range of motion measurement. Such is measured by the angle subtended by the ball upon rotation of the goniometer.

In another aspect of the invention, a goniometer is provided having an angle indicating assembly including a pair of relatively shiftable angle-indicating arms, each of the arms supported by an enlarged base, with the bases being in substantial alignment to present an outer perimeter. The goniometer also has a footed, auxiliary base operatively coupled with the assembly and shiftable between a retracted position within the perimeter defined by the bases, and an extended, use position wherein at least a part of the auxiliary base extends beyond the perimeter. The auxiliary base may be used in conjunction with the gravity-operated portion of the goniometer. Typically, the base feet are extended and placed upon the spine, neck or a mobile body part of the patient. The patient then moves appropriately, and a gravity-induced measurement is taken.

### BRIEF DESCRIPTION OF THE DRAWINGS

FIG. 1 is a front view of a preferred goniometer in accordance with the invention;

FIG. 2 is a rear view of the goniometer of FIG. 1, showing the auxiliary base of the goniometer in its retracted position in full lines, and its extended, use position in phantom;

FIG. 3 is a front view similar to that of FIG. 1, but showing the angle indicating arms of the goniometer in an aligned, overlapped relationship and in registry with the handle;

FIG. 4 is an exploded perspective view of the preferred goniometer, from the front of the goniometer;

FIG. 5 is an exploded perspective view of the preferred goniometer, from the rear of the goniometer;

FIG. 6 is a horizontal sectional view taken along lines 6-6 of FIG. 3;

FIG. 7 is a vertical sectional view taken along lines 7-7 of FIG. 3;

FIG. 8 is a schematic view illustrating use of the goniometer of the invention in a range of motion measurement at an elbow joint;

FIG. 9 is a schematic view illustrating use of the goniometer with the auxiliary base extended and placed on the spine of a patient;

FIG. 10 is a schematic view illustrating use of the device measuring wrist rotation, with a patient grasping the handle of the goniometer;

FIG. 11 is a schematic view similar to that of FIG. 10, but showing the device upon wrist rotation by the patient;

FIG. 12 is a schematic view illustrating placement of the goniometer adjacent the head and neck regions of a patient, for measuring upper cervical range of motion;

FIG. 13 is a schematic view similar to that of FIG. 12, but depicting the goniometer in its measurement position upon head movement by the patient;

FIG. 14 is a schematic view illustrating initial placement of the goniometer for measurement of cervical lateral flexion; and

FIG. 15 is a view similar to that of FIG. 1, but illustrating placement of the goniometer after the patient's cervical lateral motion, in order to determine range of such motion.

### DETAILED DESCRIPTION OF THE PREFERRED EMBODIMENT

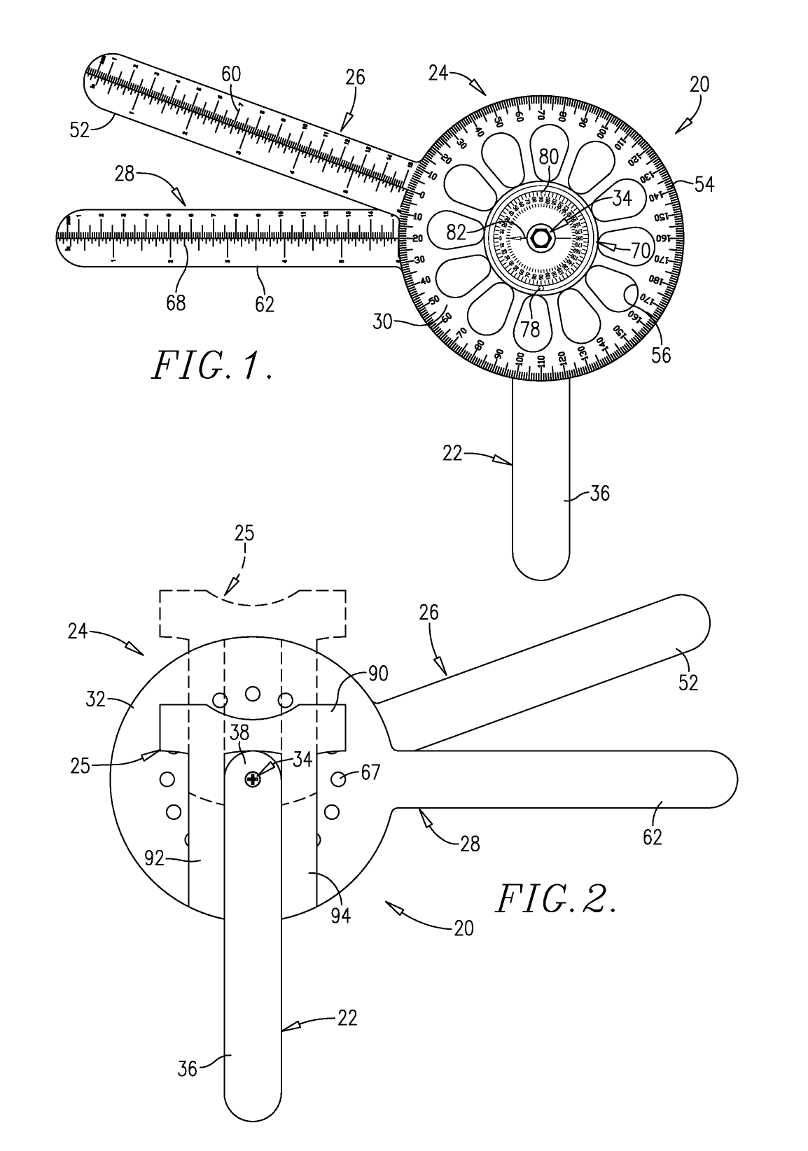

Turning now to the drawings, a preferred multiple-use goniometer 20 is illustrated in FIGS. 1 and 2 and broadly includes a handle 22 operatively coupled with and supporting an angle-indicating assembly 24, as well as a selectively useable auxiliary base 25. The assembly 24 includes a pair of elongated, angle-indicating, outer and inner arms 26 and 28, each supported by an enlarged, substantially circular, outer and inner base 30 and 32. The handle 22 and bases 30, 32 are interconnected by means of a pivot screw assembly 34. Goniometer 20 is designed to permit efficient range of motion measurements at various locations on a human patient.

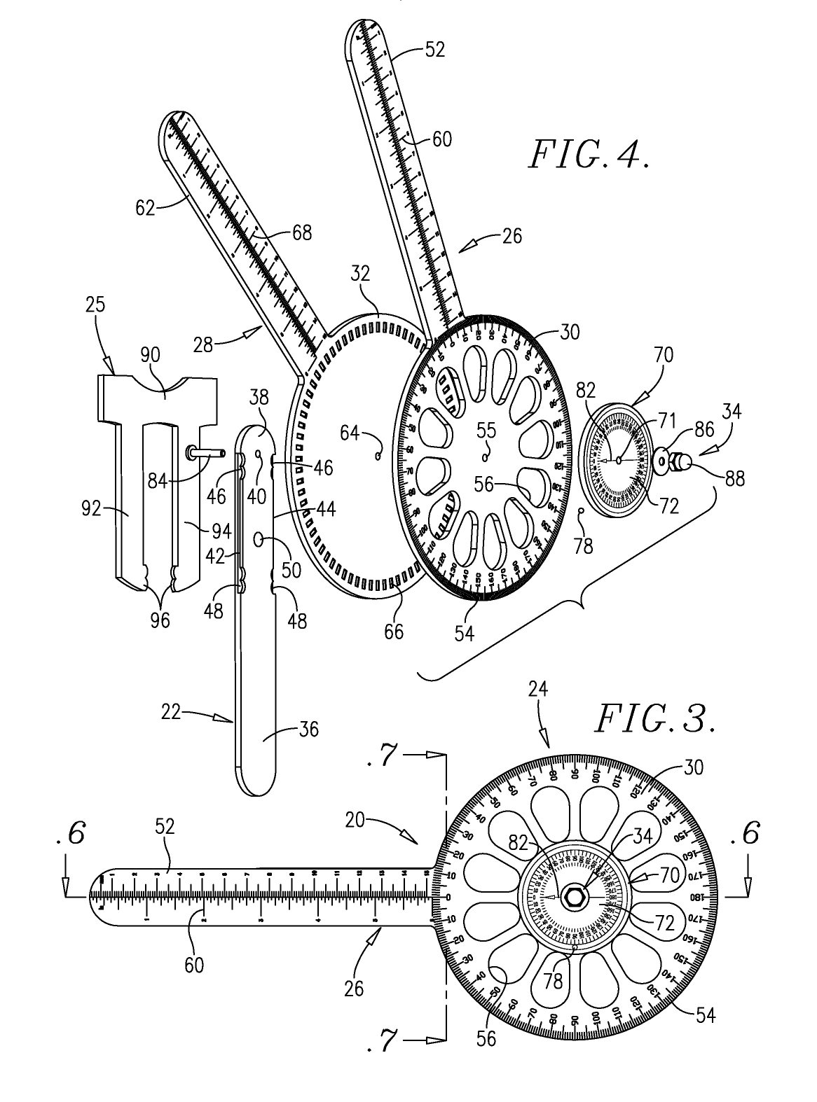

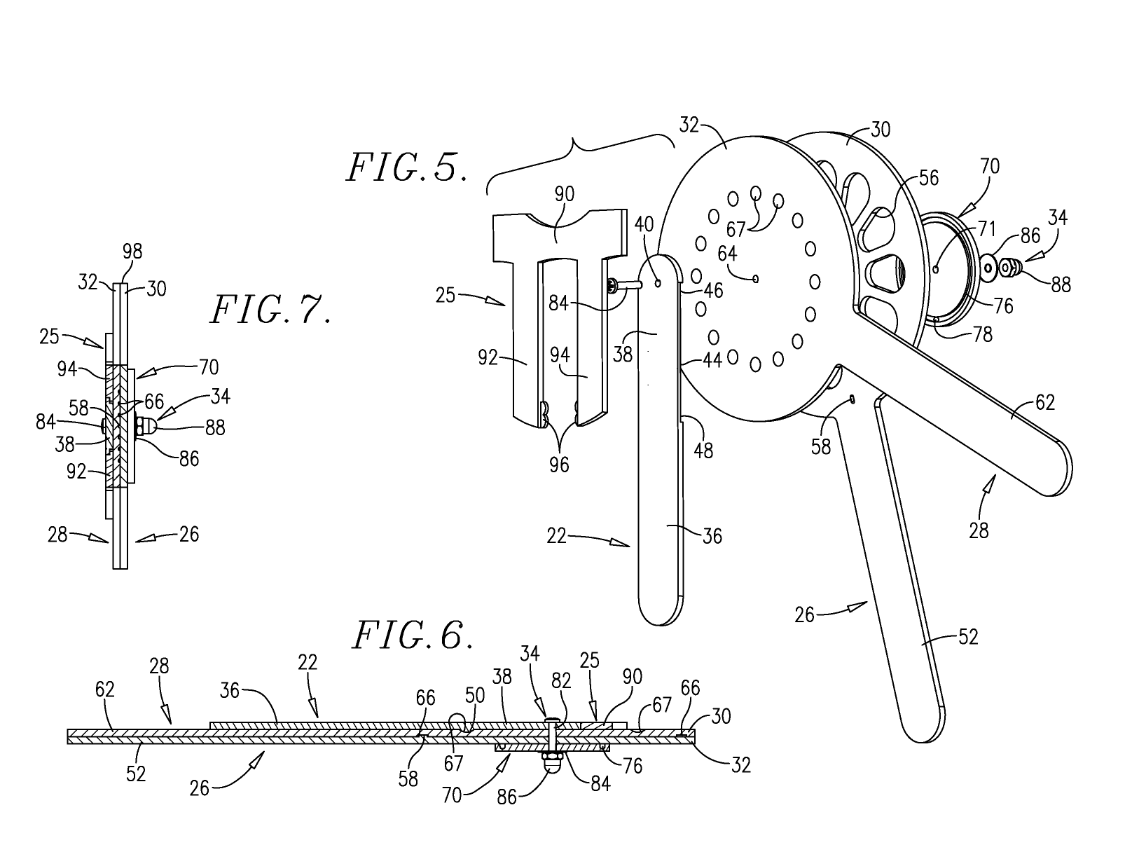

In more detail, the handle 22 is formed of ridged synthetic resin material and has a lower grasping portion 36 and an upper connection portion 38. The later has a bore 40 as well as a pair of elongated, side marginal track recesses 42 and 44 terminating in upper and lower locking detents 46, 48 which are important for purposes to be described. It will also be observed that the portion 38 has an outwardly extending locking projection 50 on the same face thereof as the track recesses 42, 44 and detents 46, 48 (see FIG. 4).

The outer arm 26 is also integrally formed of synthetic resin material and includes circular outer base 30 as well as an elongated arm component 52. The base 30 has an angular scale 54 provided on the outer face thereof, and also has a central bore 55 and a series of circumferentially spaced apart thumb movement openings 56. As best seen in FIG. 5, the face of base 30 remote from the scale 54 has a locking nib 58. The arm component 52 is provided with English and metric distance scales 60 on the outer face thereof.

The inner arm 28 is also integrally formed of synthetic resin material having the inner base 32 as well as projecting arm component 62. The base 32 has a central bore 64 as well as a plurality of circumferentially spaced apart nib-receiving recesses 66 formed on the outer face thereof. The opposed rearward face (FIG. 5) also has a plurality of circumferentially spaced apart, circular locking recesses 67. Again, the arm component 62 has English and metric distance scales 68 thereon.

The overall angle-indicating assembly 24 further includes a disk-like measurement device 70 having a central bore 71, a transparent forward face 72 with a rearward face 74 provided with a circular, peripheral track 76. The track 76 receives a freely moveable ball 78 therein. The forward face 72 has an angular scale 80, as well as a directional arrow 82. The position of ball 78 within track 76 is visible through the forward transparent face 72.

The pivot screw assembly 34 comprises a headed pivot screw 84, resilient washer 86, acorn nut 88. The assembly 34 is used to connect all of the parts making up goniometer 20.

The auxiliary base 25 includes an uppermost segment 90 together with a pair of depending, spaced-apart connection legs 92, 94. The legs 92, 94 have lowermost, inwardly extending locking projections 96.

The goniometer 20 is assembled by placing the bases outer and inner 30 and 32 in face-to-face adjacency, i.e., with the rear face of outer base 30 having nib 58 in face-to-face contact with the forward face of inner base 32 having the recesses 66. The bases 30, 32 are essentially congruent so that the bores 55 and 64 thereof are registry, with the bases cooperatively defining a common outer circular periphery or perimeter 98. Next, the device 70 with ball 78 seated within track 76 is placed against the forward face of outer base 30, such that the bore 71 aligns with bores 55 and 64. The handle 22 and auxiliary base 25 are next interfitted by placement of the leg projections 96 within the detents 48, and this combined structure is positioned in face-to-face contact with the rear face of inner base 32 in an orientation such that the locking projection 50 seats within one of the recesses 67, and the bore 40 aligns with the bores 64, 55, and 71. It will be seen that the recesses 42, 44 and detents 46, 48 are adjacent the face of base 32, thus trapping the auxiliary base 25 against the face of base 32. At this point the screw 82 is inserted through the bores 40, 64, 55 and 71, such that the threaded outer end thereof projects slightly beyond the face 72 of device 70. The washer 86 and acorn nut 88 are then installed in order to complete the interconnection between handle 22 and assembly 24. In this respect, the resilient nature of washer 86 creates a slight loading to bias together the respective locking structures between the bases 30 and 32 and between handle 22 and base 32.

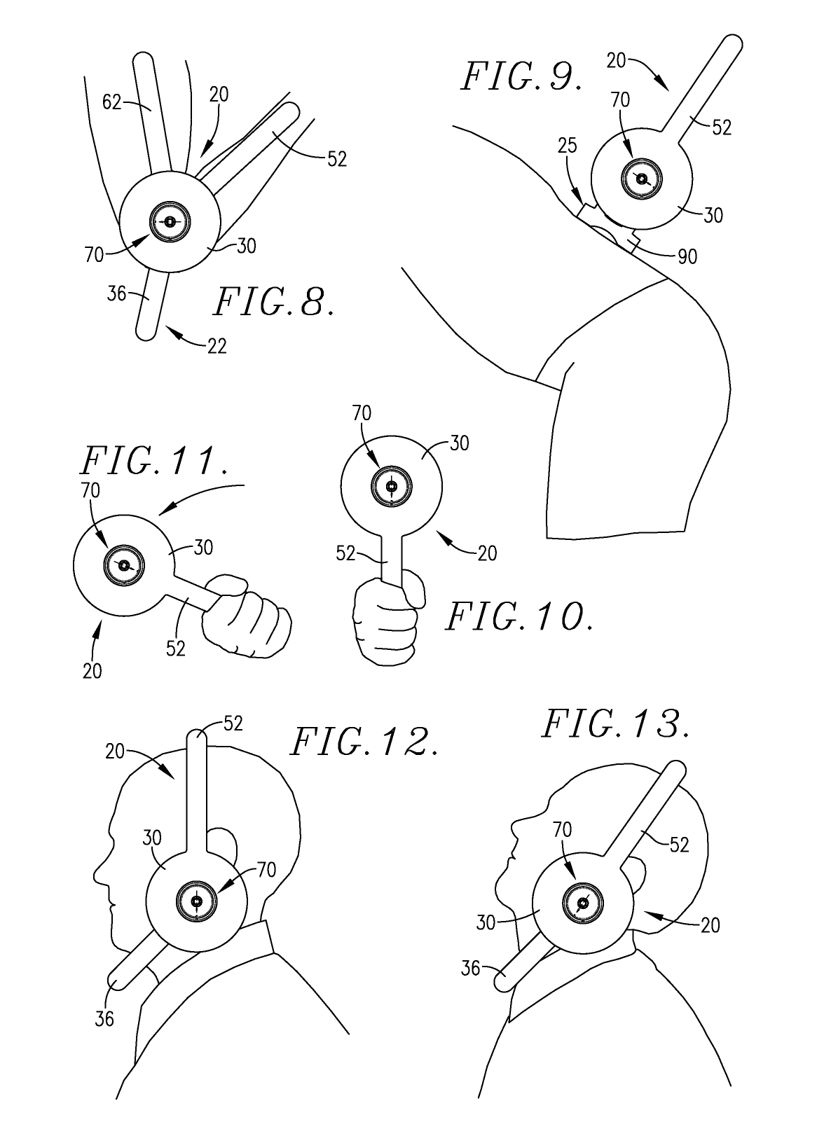

As explained above, the goniometer 20 is designed to facilitate range of motion measurements at various locations on a patient's body. A number of these possible uses are depicted in FIGS. 8-13. It should be understood, however, that these illustrated uses are exemplary only, and that skilled artisans will readily appreciate that the goniometer has a large number of uses not specifically depicted.

The goniometer 20 is most commonly used by a therapist who holds the device by grasping portion 36 of handle 22 and placing the aligned base portions 30, 32 substantially at a selected joint (e.g., knee, elbow, shoulder). The inner arm component 62 is then shifted into alignment with one of the joint-forming body parts, by grasping the component 62 and rotating it to the desired position. This involves overcoming the locking bias between the handle 22 and inner base 32, and rotation of component 62 until the handle projection 50 comes into locking engagement with the appropriate recess 67 at the selected location. Next, the base 30 and arm component 52 are adjusted to align the latter with the other joint-forming body part. This is accomplished by the therapist, using his or her thumb to engage the respective thumb movement openings 56 provided in base 30, in order to rotate the body 30 and arm 52 to the proper position. Again, such rotational movement overcomes the resilient locking bias between nib 58 and recesses 66 until the adjusted arm position is reached. In this position, the base 30 is again locked relative to base 32 because of the locking action afforded by the nib 58 and recesses 66.

Referring next to FIG. 8, the goniometer 20 is illustrated in a range of motion measurement at the elbow region of a patient. In this use, the inner and outer base portions 30, 32 are located essentially at the patient's elbow, with the arm components 52 and 62 extending along the forearm and upper arm of the patient as shown. The therapist would hold the handle 22 to support the goniometer 20, and initially position component 62 along the patient's upper arm. The therapist would then use his or her thumb to rotate the outer base 30 as described previously until the component 52 generally aligns with the patient's forearm. Upon patient movement, the arm 52 would be moved as described, giving the desired range of motion measurement.

In certain instances the arm components 52 and 62 are not useful for range of motion measurements, and instead use is made of the device 70 secured to the bases 30, 32. The body 70 in effect is a gravity-induced angular measurement device which is independent of the arm components 52, 62. In the use of the body 70, the arm components 52 and 62 are rotated to a position in essentially complete alignment with handle 22 as best seen in FIGS. 9-11. In one use shown in FIG. 9, trunk/back movement is measured through use of base 25. Thus, the auxiliary base 25 is moved to its extended position such that the segment 90 thereof extends beyond the perimeter 98 defined by the bases 30, 32, with the body locked in place owing to the interfit between locking detents 46 and the leg projections 96. The extended segment 90 is then placed at an appropriate position on the patient's trunk/back, and the device 70 is rotated to a point where track ball 78 falls to a zero position on the adjacent angular scale 80. The patient then moves his trunk/back and the range of motion is ascertained by a comparison between the initial location of ball 78 and the location thereof after the patient movement.

Another use of device 70 is illustrated in FIGS. 10 and 11. In this situation the patient grasps the aligned handle 22 and components 52 and 62 and holds the goniometer upright as depicted in FIG. 10. The position of ball 78 is set to zero by rotation of device 70. Next the patient rotates his wrist in either direction to the full extent of which he is capable. At this extreme position the location of ball 78 is noted, and this is compared with the initial zero position. In this manner, the range of wrist rotation can be readily ascertained.

FIGS. 12 and 13 illustrate a further use of goniometer 20 in the context of cervical range of motion. The therapist grasping goniometer 20 at handle section 36 moves both of the components 52, 62 into a substantially vertical orientation. This may be accomplished by initially locating the component 62 in this location and then moving the outer base 30 and component 52 into alignment with the base 32 and component 52. In any event, the patient then moves his head rearwardly to the fullest extent of which he is capable, and the therapist may then move the goniometer arm components 52, 62 to measure this range of motion.

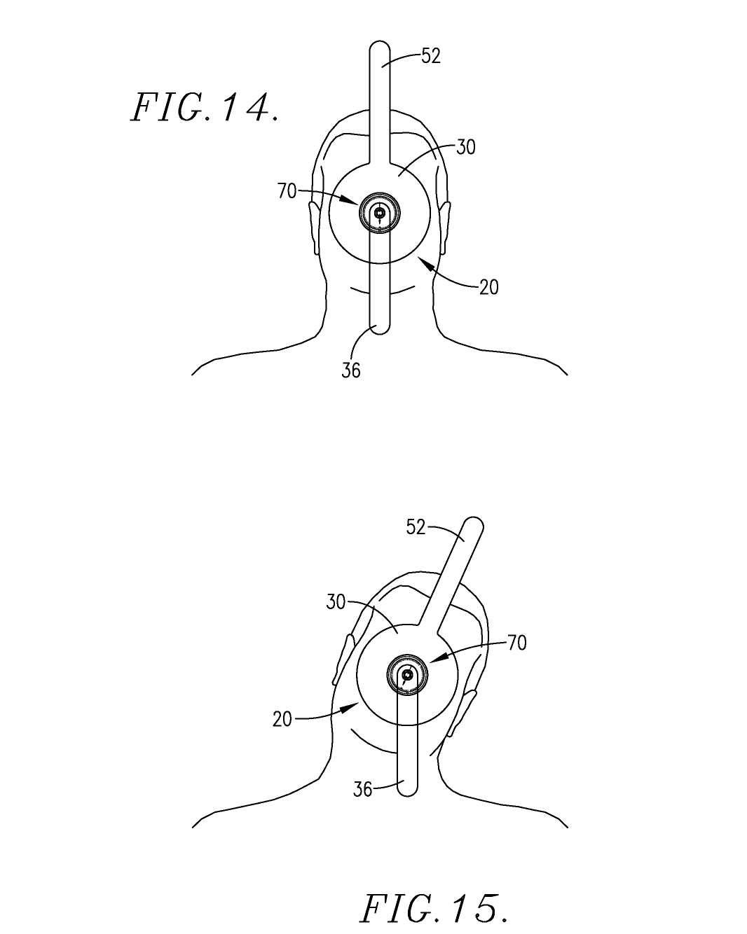

FIG. 14 illustrates use of goniometer 20 for the measurement of cervical lateral flexion. In this use, the goniometer 20 is centered at the patient's nose, as shown in FIG. 14. Thereafter, the patient bends his head laterally to the maximum extent (FIG. 15), and the therapist moves the arm 52 as shown to provide a range of motion measurement.

Although the exemplified uses of goniometer 20 have been explained in terms of common therapist manipulations, it will be appreciated that a given user may elect to deploy and use goniometer 20 in ways different than those explained. For example, the device 70 can be used in the lateral cervical flexion range of motion measurement of FIGS. 14-15.

The goniometer 20 posses a number of advantages not available in conventional units. Foremost among these are the multiple ways the goniometer may be used, thus allowing a therapist to reduce the equipment needed for therapy sessions. Also, owing to the one-handed operation of goniometer 20, the therapist may better assist patients as needed and/or record results, thus eliminating the need for a second therapist or assistant. In addition, the various scales provided on the base 30, device 70, and arms 52, 62 may be brightly and/or differently colored to give maximum contrast and enhanced readability.

We claim:

1. A multiple-use goniometer comprising:
a handle; and
an angle-indicating assembly operatively coupled with and supported by said handle, said assembly including a pair of elongated, angle-indicating arms pivotal relative to each other and selectively moveable to establish different angles between the arms.

2. The goniometer of claim 1, including pivot structure operatively coupling said handle to said arms for selective pivotal movement of the arms relative to the handle and to each other.

3. The goniometer of claim 2, each of said arms having an enlarged base, said bases being pivotally coupled together by said pivot structure.

4. The goniometer of claim 3, said bases being generally circular and in alignment with each other.

5. The goniometer of claim 3, there being an outer base and an inner base, said outer base having manual rotational movement structure permitting rotation of the outer base and the corresponding arm by thumb contact with the rotational movement structure.

6. The goniometer of claim 5, said rotational movement structure comprising a plurality of individual apertures formed in said outer base and oriented so that a person holding the goniometer handle may, by thumb movement, rotate the outer base and corresponding arm.

7. The goniometer of claim 1, including an angle scale located in order to give an angular measurement of the angle between said arms when the arms are pivoted to different relative positions.

8. The goniometer of claim 1, including a separate, gravity-operated angular measurement device operatively coupled with said assembly.

9. The goniometer of claim 8, said separate angular measurement device comprising a body having a circular track, a ball seated within said track and moveable there along, and a scale oriented to permit measurement of the angle subtended by said ball between a first reference position and a second measurement position, when the goniometer is rotated.

10. The goniometer of claim 1, including an auxiliary measurement base operatively coupled with said handle and shiftable between a retracted position and an extended use position.

11. The goniometer of claim 10, including structure for holding said auxiliary base at said retracted and use positions.

12. The goniometer of claim 1, each of said arms having an enlarged base, said bases being in face-to-face adjacency, there being first locking structure operable to lock said arms at a plurality of different, relatively pivoted positions.

13. The goniometer of claim 12, said first locking structure including a plurality of first recesses formed in one of said enlarged bases, and a first locking projection formed in the other of said bases, said first projection being alternately received within respective first recesses upon relative pivoting of the arms.

14. The goniometer of claim 1, each of said arms having an enlarged base, said bases being in face-to-face adjacency, said handle being in face-to-face adjacency with one of said enlarged bases, there being second locking structure operable to lock said assembly at a plurality of different, relatively pivoted positions between the handle and the assembly.

15. The goniometer of claim 14, said second locking structure including a plurality of second recesses formed in one of the handle and the one enlarged base adjacent said handle, and a second projection formed in the other of said handle and the one enlarged base adjacent the handle, said second projection being alternately received within respective second recesses.

16. The goniometer of claim 15, said second recesses being formed in said one enlarged head, and said second projection being formed on said handle.

17. A multiple-use goniometer comprising:
an angle indicating assembly including a pair of angle-indicating arms, each of said arms having an enlarged base, said bases being in substantial alignment to present an outer periphery, said enlarged bases being pivotally coupled together to permit relative angular movement between the arms; and
an auxiliary base operatively coupled with said assembly and shiftable between a retracted position within the perimeter defined by said bases, and an extended, use position wherein at least a part of the auxiliary base extends beyond said perimeter.

18. The goniometer of claim 17, including a handle operably coupled with and supporting said assembly, said auxiliary base being operably secured to said handle.
